(19) United States
(12) Patent Application Publication
(10) Pub. No.: US 2026/0169210 A1
(43) Pub. Date: Jun. 18, 2026

(54) BANDPASS FILTER, OPTICAL STRUCTURE INCLUDING THE SAME, AND MANUFACTURING METHOD THEREOF

(71) Applicant: VisEra Technologies Company Limited, Hsin-Chu City (TW)

(72) Inventors: Shih-Liang KU, Hsin-Chu City (TW); Po-Chun HUANG, Hsin-Chu City (TW); Ming-Lun SHIH, Hsin-Chu City (TW); Tzu-Ting HUANG, Hsin-Chu City (TW)

(21) Appl. No.: 18/984,071

(22) Filed: Dec. 17, 2024

(51) Int. Cl. G02B 5/26

(52) U.S. Cl. CPC G02B 5/26

(57) ABSTRACT

A bandpass filter includes a first reflector layer, a second reflector layer disposed on the first reflector layer, and a space layer disposed between the first reflector layer and the second reflector layer in a first direction. The space layer includes a plurality of microstructures including a first material and a base layer surrounding the microstructures and including a base material with a refractive index that is different from that of the first material. The microstructures are arranged in different portions of the base layer at different densities, the effective refractive indices of portions of the space layer corresponding to the different portions of the base layer will be different from each other. By including the space layer, the bandpass filter can be transformed from a single bandpass filter to a multi-bandpass filter.

### BACKGROUND OF THE INVENTION

### Field of the Invention

The present disclosure relates to a bandpass filter, an optical structure including the same, and a manufacturing method thereof.

### Description of the Related Art

A bandpass filter (BPF) is a device that allows one or more specified wavelength bands to pass and rejects (or attenuates) others. The bandpass filter is a common filter suitable for use in a wide range of optical devices. Examples of these optical devices include, but are not limited to, environmental testing devices, sensors, flame photometry devices, spectral radiometer devices, medical diagnostics devices, chemical analysis devices, and biotech instrumentations.

The bandpass filter is one of the simplest and most economical ways to transmit light in a specific wavelength band and reject light in all other unwanted wavelength bands. One type of bandpass filter consists essentially of two reflecting stacks and a spacer layer disposed between the two reflecting stacks.

### BRIEF SUMMARY OF THE INVENTION

The disclosure provides a bandpass filter, an optical structure including the bandpass filter, and a manufacturing method of the bandpass filter. Based on the Fabry-Pérot formula shown below (in the formula, m is a constant), the central wavelength λ₀ of the wavelength band of the bandpass filter is proportional to the thickness d and the refractive index no of the space layer included the bandpass filter.

m(λ₀/2)=n₀*d (Fabry-Pérot formula)

The bandpass filter of the present disclosure changes the central wavelength of the wavelength band thereof by changing the effective refractive index of the space layer included in the bandpass filter. In some embodiments, the bandpass filter of the present disclosure may include a plurality of regions having central wavelengths of wavelength bands different from each other by making the effective refractive indexes of space layers of the regions different from each other.

An embodiment of the present disclosure provides a bandpass filter. The bandpass filter includes a first reflector layer, a second reflector layer disposed on the first reflector layer, and a space layer disposed between the first reflector layer and the second reflector layer in a first direction. The space layer includes a plurality of microstructures including a first material having a refractive index and a base layer surrounding the microstructures and including a base material having a different refractive index than the first material.

An embodiment of the present disclosure provides an optical structure. The optical structure includes a sensor layer and a bandpass filter disposed on the sensor layer. The bandpass filter includes a first reflector layer, a second reflector layer disposed on the first reflector layer, and a space layer disposed between the first reflector layer and the second reflector layer in a first direction. The space layer includes a plurality of microstructures including a first material having a refractive index and a base layer surrounding the microstructures and including a base material having a different refractive index than the first material.

In addition, an embodiment of the present disclosure provides a manufacturing method of a bandpass filter. The manufacturing method of the bandpass filter includes forming a first reflector layer. The method includes forming a base layer comprising a plurality of openings through the base layer on the first reflector layer. Alternatively, the base layer may comprise a plurality of recesses in the base layer or the base layer may comprise a plurality of recesses and openings. The method includes forming a plurality of microstructures in each of the openings or recesses to form a space layer. The method includes forming a second reflector layer on the space layer. The base layer includes a base material having a refractive index. The microstructures include a first material having a different refractive index than the base material.

### BRIEF DESCRIPTION OF THE DRAWINGS

The present disclosure can be more fully understood by reading the subsequent detailed description and examples with references made to the accompanying drawings, wherein:

FIG. 1 is a schematic cross-sectional view of a bandpass filter according to an embodiment of the present disclosure;

FIG. 2 is a schematic cross-sectional view of a bandpass filter according to another embodiment of the present disclosure;

FIG. 3 is a schematic cross-sectional view of an optical structure according to an embodiment of the present disclosure;

FIG. 4 is a flowchart of a manufacturing method of a bandpass filter according to an embodiment of the present disclosure;

FIGS. 5A, 6A, 7A, and 8A are schematic cross-sectional views of a bandpass filter obtained after various steps of the manufacturing method shown in FIG. 4; and

FIGS. 5B, 6B, 7B, and 8B are schematic top views of a bandpass filter obtained after various steps of the manufacturing method shown in FIG. 4;

FIGS. 9A to 9D are transmittance spectrums of different regions of a bandpass filter according to an embodiment of the present disclosure; and

FIG. 9E is a transmittance spectrum of a bandpass filter according to an embodiment of the present disclosure.

### DETAILED DESCRIPTION OF THE INVENTION

The following description is made for the purpose of illustrating the general principles of the disclosure and should not be taken in a limiting sense. The scope of the disclosure is determined by reference to the appended claims. Reference will now be made in detail to exemplary embodiments of the present disclosure, examples of which are illustrated in the accompanying drawings. Whenever possible, the same reference numbers are used in the drawings and descriptions to refer to the same or similar parts.

The directional terms mentioned in the disclosure, such as “up”, “down”, “front”, “back”, “left”, “right” only refer to the directions of the accompanying drawings. Therefore, the directional terms used herein are illustrative and not intended to limit the disclosure. It should be understood that if a device or structure in an accompanying drawing is turned so that it is upside down, elements recited on the “bottom” side will become the elements on the “top” side. In the accompanying drawings, the drawings illustrate general features of the methods, structures and/or materials used in specific embodiments. However, these accompanying drawings should not be construed as defining or limiting the scope or property of what is covered by these embodiments. For example, relative sizes, thicknesses and positions of the various layers, regions and/or structures may be reduced or enlarged for clarity.

In the present disclosure, descriptions of a structure (or layer, element or substrate) being on/above another structure (or layer, element or substrate) may mean that the two structures are adjacent and directly connected, or that the two structures are adjacent and indirectly connected. Indirect connection means that there is at least one intermediate structure (or intermediate layer, intermediate element, intermediate substrate, intermediate spacer) between two structures. A lower surface of the structure is adjacent to or directly connected to an upper surface of the intermediate structure, and an upper surface of the other structure is adjacent to or directly connected to a lower surface of the intermediate structure. The intermediate structure may be a single-layer or multi-layer physical structure or a non-physical structure without limitation. In the disclosure, when a structure is disposed “on” another structure, it may mean that the structure is “directly” on the other structure, or that the structure is “indirectly” on the other structure, i.e. there is at least one structure is between the structure and the other structure.

In the disclosure, the terms “about”, “equal to”, “equal” or “the same”, “substantially” or “approximately” usually indicates a value of a given value or range that varies within 20%, or a value of a given value or range that varies within 10%, within 5%, or within 3%, or within 2%, or within 1%, or within 0.5%.

Ordinal numbers used in the specification and claims, such as “first”, “second”, etc., are used to modify elements. The ordinal numbers do not imply or represent numbers of the element (or elements). The ordinal numbers do not represent the order of one element over another or the order of manufacturing method. The ordinal numbers are only used to clearly distinguish two elements having the same name. The claims and the specification may not use the same terms. Therefore, the first element in the specification may be the second element in the claim.

It should be understood that according to the embodiments of the present disclosure, the depth, thickness, width or height of each element, or the space of the elements or the distance between them may be measured using an optical microscope (OM), a scanning electron microscope (SEM), a film thickness profile measuring gauge (α-step), an elliptical thickness gauge, or other suitable measurement methods. According to some embodiments, a scanning electron microscope and focused ion beam (FIB) may be used to obtain a cross-sectional structural image including the elements to be measured, and to measure the depth, thickness, width or height of each element, or the space or distance between the elements. In particular, the scanning electron microscope can be used to locate a position where the cross-sectional structural image is to be taken, the FIB can be used to excavate the exact location where the cross-sectional structural image is to be taken, and the scanning electron microscope is then used to obtain the sectional structural image after the excavation has been completed.

Unless otherwise defined, all terms (including technical and scientific terms) used herein have the same meaning as commonly understood by a person skilled in the art to which the disclosure pertains. It will be further understood that terms, such as those defined in commonly used dictionaries, should be interpreted as having a meaning consistent with the relevant technology and the context or background of this disclosure and will not be interpreted in an idealized or overly formal sense unless expressly so defined herein.

The term “cross-sectional view” herein refers to a view intercepted along a normal direction (a first direction D1) of a bandpass filter. The term “top view” herein refers to a view viewed from a normal direction (the first direction D1) of a bandpass filter. The term “A surrounding B” used herein means that at least a portion of B is within A, and in the cross-sectional view, A is in direct or indirect contact with at least one side surface of B. The phrase “A directly contacts B” used herein means that there is no intermediary structure between A and B.

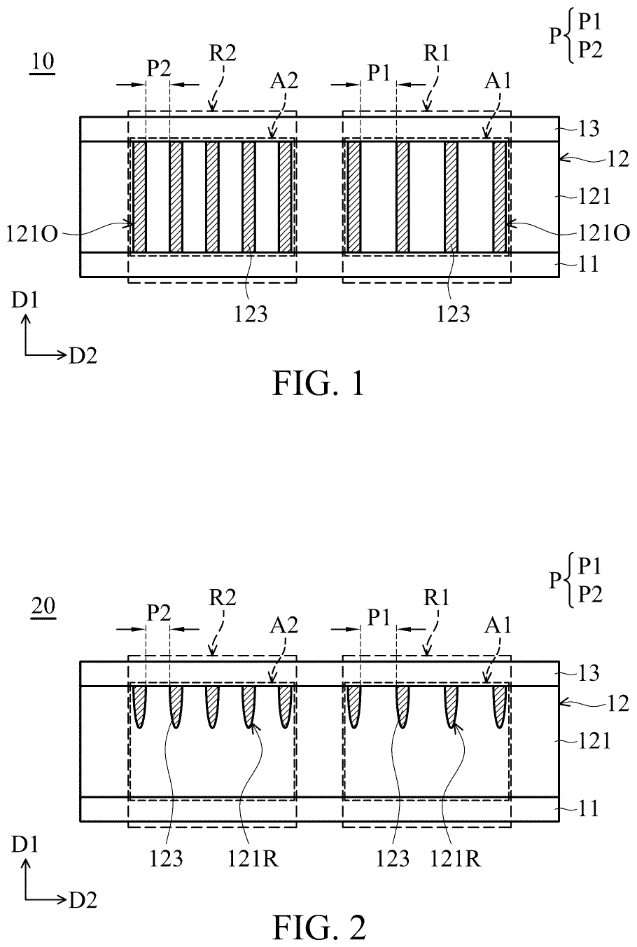

An embodiment of the present disclosure provides a bandpass filter having a wavelength band. That is, the bandpass filter of the present disclosure transmits light in the wavelength band and rejects all light in wavelength bands other than the wavelength band. FIG. 1 is a schematic cross-sectional view of a bandpass filter 10 according to an embodiment of the present disclosure. FIG. 2 is a schematic cross-sectional view of a bandpass filter 20 according to another embodiment of the present disclosure. As shown in FIGS. 1 and 2, each of the bandpass filter 10 and the bandpass filter 20 includes a first reflector layer 11, a second reflector layer 13 disposed on the first reflector layer 11, and a space layer 12 disposed between the first reflector layer 11 and the second reflector layer 13 in a first direction D1. The space layer 12 includes a plurality of microstructures 123 including a first material having a refractive index and a base layer 121 surrounding the microstructure 123 and including a base material having a different refractive index than the first material.

Each of the first reflector layer 11 and the second reflector layer 13 may be a high reflector layer having a reflection rate of 60-99.99% in a wavelength range of 400-700 nm, 700-1100 nm, or 1100-3400 nm. In some embodiments, the first reflector layer 11 may include alternately stacked high refractive index layers and low refractive index layers, but the present disclosure is not limited thereto. In some embodiments, the first reflector layer 11 may include a metal layer. For example, the first reflector layer 11 may include a base coated with a metal layer, but the present disclosure is not limited thereto. Similar to first reflector layer 11, the second reflector layer 13 may also include alternately stacked high refractive index layers and low refractive index layers or include a metal layer. Structures of the first reflector layer 11 and the second reflector layer 13 may be the same as or different from each other.

The high refractive index layer may include a high refractive index material and the low refractive index layer may include a low refractive index material. In the present disclosure, there are no restrictions or limitations on the high refractive index material as long as the refractive index thereof is higher than the refractive index of the low refractive index material. Also, in the present disclosure, there are no restrictions or limitations on the low refractive index material as long as the refractive index thereof is lower than the refractive index of the high refractive index material. In some embodiments, the high refractive index material may include, but is not limited to, Ta₂O₅, Nb₂O₅, TiO₂, SiN, SiH, GaS, GeSn, other suitable materials, or any combination thereof. In some embodiments, the low refractive material may include, but is not limited to, SiO₂, MgF₂, other suitable materials, or any combination thereof.

The base layer 121 of the space layer 12 disposed between the first reflector layer 11 and the second reflector layer 13 may be a single layer or a multi-layer structure including plurality of layers. The thickness of the base layer 121 may vary according to the desired wavelength band of the bandpass filter. In some embodiments, the thickness of the base layer 121 may be 150±5 nm when the wavelength band of the bandpass filter is in a blue light wavelength band. In some embodiments, the thickness of the base layer 121 may be 171±5 nm when the wavelength band of the bandpass filter is in a green light wavelength band. In some embodiments, the thickness of the base layer 121 may be 209±5 nm when the wavelength band of the bandpass filter is in a red light wavelength band. The base layer 121 may include a high refractive index material, a low refractive index material, or a combination thereof. Examples of the high refractive index material and the low refractive index material are as mentioned above, and will not be repeated here.

In some embodiments, the base layer 121 may include a plurality of openings 1210 through the base layer 121 as shown in FIG. 1, but the present disclosure is not limited thereto. In some embodiments, different portions of the base layer 121 include the openings 1210 at different densities. In some embodiments, the sum of the areas of the openings in each of the portions divided by the area of the portion multiplied by 100% may be within a range of 0% to 30%, 5% to 29%, 10% to 28.5%, or 15% to 28.4%. In some embodiments, the sum of the areas of the openings in each of the portions divided by the area of the portion multiplied by 100% in different portions may be different from each other. For examples, in some embodiments, the base layer 121 may have a first portion A1 and a second portion A2, the first portion A1 of the base layer 121 include the openings 1210 at a first density, and the second portion A2 of the base layer 121 include the openings 1210 at a second density. The sum of the areas of the openings in the first portion A1 divided by the area of the first portion A1 may be different from the sum of the areas of the openings in the second portion A2 divided by the area of the second portion A2. The interval between the centers of two adjacent openings 1210 may be smaller than the central wavelength of the desired wavelength band of the bandpass filter. In some embodiments, the interval is within a range of 200 nm to 1700 nm, but the present embodiment is not limited thereto. In some embodiments, intervals between the centers of two adjacent openings 1210 in different portions of the base layer 121 may be different from each other.

The openings 1210 may include various opening shapes. In some embodiments, when viewed from the first direction D1, one of the openings 1210 has an opening shape that is a circle, a square, a triangle, a pentagon, a hexagon, an octagon, a star, or another suitable shape. In some embodiments, the opening shape of the opening 1210 may have a maximum width within a range of 120 nm to 1580 nm. In embodiments where the opening shape of the opening 1210 is a circle, the maximum width of the opening 1210, i.e. a diameter of the circle, is within a range of 120 nm to 1580 nm. The openings 1210 may include various cross-sectional shapes. In some embodiments, in a cross-sectional view taken along the first direction D1, one of the openings 1210 may have a cross-sectional shape that is a rectangle, a square, a trapezoid, an inverted trapezoid, or another suitable shape.

In some embodiments, the base layer 121 may include a plurality of recesses 121R in the base layer 121 as shown in FIG. 2, but the present disclosure is not limited thereto. In some embodiments, the base layer 121 may include a combination of the openings 1210 and the recesses 121R. In some embodiments, different portions of the base layer 121 include the recesses 121R at different densities. For examples, in some embodiments, the base layer 121 may have a first portion A1 and a second portion A2 separated from the first portion A1 in a second direction D2 perpendicular to the first direction D1, the first portion A1 of the base layer 121 include the recesses 121R at a first density, and the second portion A2 of the base layer 121 include the recesses 121R at a second density. The interval between the centers of two adjacent recesses 121R may be smaller than the central wavelength of the desired wavelength band of the bandpass filter. In some embodiments, the interval is within a range of 200 nm to 1700 nm, but the present embodiment is not limited thereto. In some embodiments, the intervals between the centers of two adjacent recesses 121R in different portions of the base layer 121 may be different from each other.

The recesses 121R may have a variety of possible recess shapes. In some embodiments, when viewed from the first direction D1, one of the recesses 121R has a recess shape that is a circle, a square, a triangle, a pentagon, a hexagon, an octagon, a star, or another suitable shape. In some embodiments, the recess shape of the recess 121R has a maximum width of 120 nm to 1580 nm. In embodiments where the recess shape of the recess 121R is a circle, the maximum width of the recess 121R, i.e. the diameter of the circle, is within a range of 120 nm to 1580 nm. The recesses 121R may include various cross-sectional shapes. In some embodiments, in a cross-sectional view taken along the first direction D1, one of the recesses 121R has a cross-sectional shape that is a rectangle, a square, a trapezoid, an inverted trapezoid, an inverted triangle, a semi-circle, a U-shape, a semi-ellipse, or another suitable shape.

Each of the microstructures 123 is disposed in one of the openings 1210 or the recesses 121R. Accordingly, cross-sectional shapes and shapes of the microstructures 123 may be substantially the same as the cross-sectional shapes and the opening shapes of the openings 1210 or the cross-sectional shapes and the recess shapes of the recesses 121R. In some embodiments, the microstructures 123 may be arranged in the first portion A1 of the base layer 121 at the above first density and the microstructures 123 may be arranged in the second portion A2 of the base layer 121 at the above second density that is different from the first density, but the present disclosure is not limited thereto. In some embodiments, the sum of the areas of the microstructures 123 in the first portion A1 divided by the area of the first portion A1 and the sum of the areas of the openings in the second portion A2 divided by area of the second portion A2 may be in the above range. In some embodiments, the sum of the areas of the microstructures 123 in the first portion A1 divided by area of the first portion A1 may be different from the sum of the areas of the openings in the second portion A2 divided by area of the second portion A2. In some embodiments, the material of the microstructures 123 in the first portion A1 of the base layer 121 is different from the material of the microstructures 123 in the second portion A2 of base layer 121.

The pitch P between the centers of two adjacent microstructures 123 may be substantially the same as the interval between the centers of two adjacent openings 1210 or recesses 121R. That is, the pitch P between the centers of two adjacent microstructures 123 is smaller than the central wavelength of the wavelength band of the bandpass filter. In some embodiments, the pitch P is within a range of 200 nm to 1700 nm, but the present embodiment is not limited thereto. In embodiments where the pitch P is within the range described above, the microstructures 123 will not produce a diffraction effect. In some embodiments, pitches P between the centers of two adjacent microstructures 123 in different portions of the base layer 121 may be different from each other. For example, in some embodiments, a first pitch P1 between centers of two adjacent microstructures 123 in the first portion A1 of the base layer 121 is different from a second pitch P2 between the centers of two adjacent microstructures 123 in the second portion A2 of the space layer 12.

Each of the microstructures 123 may include the first material having a refractive index. In the present disclosure, there are no restrictions or limitations on the first material as long as the refractive index thereof is different from a refractive index of the base material. Each of the microstructures 123 may have a one-piece structure or a microstack structure including layers stacked on each other. In embodiments where the microstructure 123 has a one-piece structure, the one-piece structure includes the first material having a refractive index different from a refractive index of the base material of the base layer 121. In embodiments where the microstructure 123 has a microstack structure that includes layers stacked on each other, at least one of the layers of the microstack structure includes the first material, and another one of the layers of the microstack structure includes another material. In some embodiments, the refractive index of the first material is different than the refractive index of the other material. There are no restrictions or limitations on the other material as long as its refractive index is different than the first material. Examples of the first material may include, but are not limited to, Nb₂O₅. Examples of the other material may include, but are not limited to, Al₂O₃.

In embodiments where the microstructures 123 are arranged in different portions of the base layer 121 at different densities, effective refractive indices of portions of the space layer 12 corresponding to the different portions of the base layer 121 will different from each other. In embodiments where the microstructures 123 arranged in different portions of the base layer 121 include different structures, effective refractive indices of portions of the space layer 12 corresponding to the different portions of the base layer 121 will different from each other. In embodiments where the microstructures 123 arranged in different portions of the base layer 121 include different materials, effective refractive indices of portions of the space layer 12 corresponding to the different portions of the base layer 121 will different from each other.

The bandpass filter includes the space layer 12 above may include regions have different wavelength bands from each other. For example, in some embodiments, each of the bandpass filter 10 and the bandpass filter 20 includes a first region R1 and a second region R2 separated from the first region R1 in the second direction D2. The first region R1 corresponding to the first portion A1 has a first wavelength band and the second region R2 corresponding to the second portion A2 has a second wavelength band different from the first wavelength band. The first region R1 transmits light of the first wavelength band and rejects all light of wavelength bands other than the first wavelength band, and the second region R2 transmits light of the second wavelength band different from the first wavelength band and rejects all light of wavelength bands other than the second wavelength band. In some embodiments, the first wavelength band being different from the second wavelength band indicates that a central wavelength of the first wavelength band is different from a central wavelength of the second wavelength band.

The bandpass filter of the present disclosure including the above structure can adjust a central wavelength of a wavelength band thereof by changing the effective refractive index of a space layer included in the bandpass filter. Further, in some embodiments, the bandpass filter of the present disclosure including the above structure can have regions having wavelength bands different from each other by making the effective refractive index of a space layer of the regions different from each other.

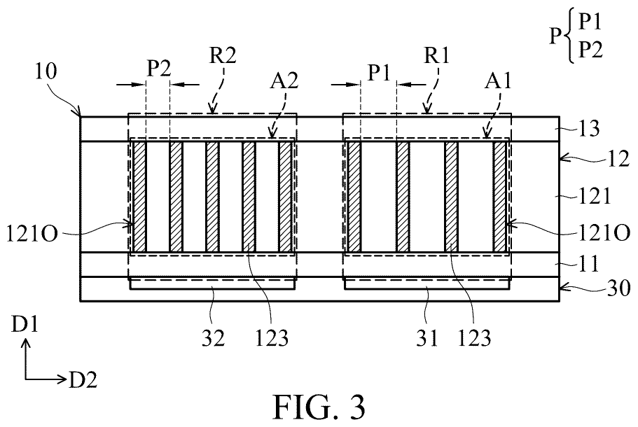

An embodiment of the present disclosure provides an optical structure. FIG. 3 is a schematic cross-sectional view of an optical structure according to an embodiment of the present disclosure. As shown in FIG. 3, the optical structure includes a sensor layer 30 and the bandpass filter 10 as shown in FIG. 1 above, and the bandpass filter 10 is disposed on the sensor layer 30.

The bandpass filter 10 includes a first region R1 and a second region R2 separated from the first region R1 in the second direction D2. Some of the microstructures 123 are arranged in the first region R1 at a first density and some of the other microstructures 123 are arranged in the second region R2 at a second density that is different from the first density. Therefore, the first region R1 of the bandpass filter 10 has a first wavelength band and the second region R2 of the bandpass filter 10 has a second wavelength band different from the first wavelength band.

The sensor layer 30 may include a plurality of sensors. In some embodiments, the sensor layer 30 includes a first sensor 31 corresponding to the first region R1 and a second sensor 32 corresponding to the second region R2. Examples of the first sensor 31 and the second sensor 32 may independently include a CMOS image sensor, a fingerprint sensor, an image sensor, an ambient sensor, a light signal sensor, a laser component, other suitable sensor, or any combination thereof, but the present disclosure is not limited thereto. The first sensor 31 and the second sensor 32 may be the same as or different from each other.

The optical structure of the present disclosure including the above structure can convert a single bandpass filter into a multi-bandpass filter by adding a microstructure process to the deposition process of the single-bandpass filter, these multiple bandpass filters share first and second reflector layer. This optical structure helps reduce the cost and time of forming a multi-channel bandpass filter.

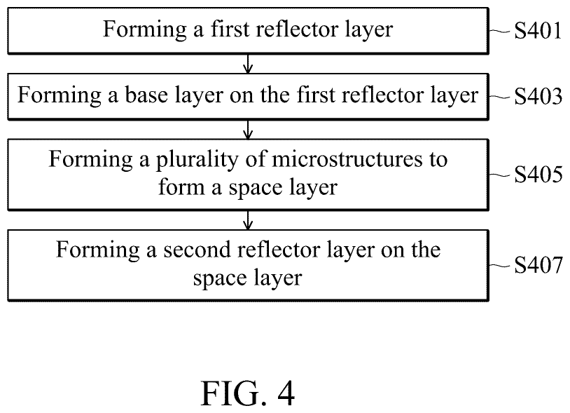

An embodiment of the present disclosure provides a manufacturing method of the bandpass filter. FIG. 4 is a flowchart of the manufacturing method of the bandpass filter according to an embodiment of the present disclosure. As shown in FIG. 4, the manufacturing method of the bandpass filter includes the following steps. Step S401 involves forming a first reflector layer. Step S403 involves forming a base layer on the first reflector layer, wherein the base layer comprises a plurality of openings through the base layer, a plurality of recesses in the base layer, or a combination thereof. Step S405 involves forming a plurality of microstructures, wherein each microstructure is in each of the openings, in each of the recesses, or in both, to form a space layer. Step S407 involves forming a second reflector layer on the space layer. The base layer formed in step S403 includes a base material having a refractive index. The microstructures formed in step S405 include a first material that has a different refractive index than the base material.

The manufacturing method of the bandpass filter of the present disclosure is not limited to the following embodiment. Additional steps or operations can be provided before, during, and/or after the steps described in the following embodiment. Some of the steps that are described can be replaced or eliminated for different embodiments. Although the following embodiment is discussed with steps or operations performed in a particular order, these steps or operations may be performed in another logical order.

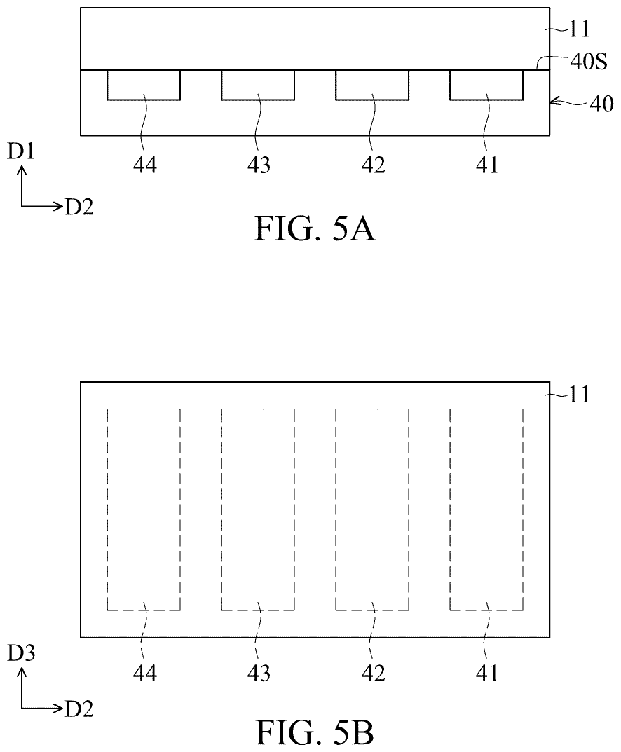

FIG. 5A is a schematic cross-sectional view of a bandpass filter obtained after step S401 of the embodiment, and FIG. 5B is a schematic top view of the bandpass filter of FIG. 5A. In FIGS. 5A and 5B, step S401 is performed on a product having sensors, but the present disclosure is not limited thereto. In some embodiments, step S401 may be performed on a substrate or other suitable structure.

In the embodiment shown in FIG. 5A, step S401 is performed on a product 40 having a first sensor 41, a second sensor 42, a third sensor 43, and a fourth sensor 44, but the present disclosure is not limited thereto. In some embodiments, the product 40 may have less than or more than four sensors. As shown in FIG. 5, the product 40 has a top surface 40S perpendicular to the first direction D1. The first sensor 41, the second sensor 42, the third sensor 43, and the fourth sensor 44 of the product 40 are separated from each other in directions that are perpendicular to the first direction D1. That is, projections of the first sensor 41, the second sensor 42, the third sensor 43, and the fourth sensor 44 of the product 40 onto the top surface 40S are not overlap each other. The first reflector layer 11 is formed on the top surface 40S of the product 40. In some embodiments, the first reflector layer 11 may cover the entire top surface 40S of the product 40, and cover all of the first sensor 41, the second sensor 42, the third sensor 43, and the fourth sensor 44 of the product 40 as shown in FIGS. 5A and 5B, but the present disclosure in not limited thereto. In some embodiments, the first reflector layer 11 may cover a portion of the top surface 40S of the product 40, and cover only some of the first sensor 41, the second sensor 42, the third sensor 43, and the fourth sensor 44 of the product 40.

The first reflector layer 11 formed in step S401 may be a high reflector layer having a reflection rate of 60-99.99% in a wavelength range of 400-700 nm, 700-1100 nm, or 1100-3400 nm. In some embodiments, step S401 may include alternately depositing high refractive index layers and low refractive index layers in the first direction on the top surface 40S of the product 40 to form the first reflector layer 11. The high refractive index layer may include a high refractive index material and the low refractive index layer may include a low refractive index material. Examples of the high refractive index material and the low refractive index material are as mentioned above, and will not be repeated here. The process for depositing high refractive index layers and low refractive index layers may include but not limited to a screen printing process, a physical vapor deposition (PVD) process, an ink jet printing process, a spin coating process, a chemical vapor deposition (CVD) process, other suitable methods, or any combination thereof.

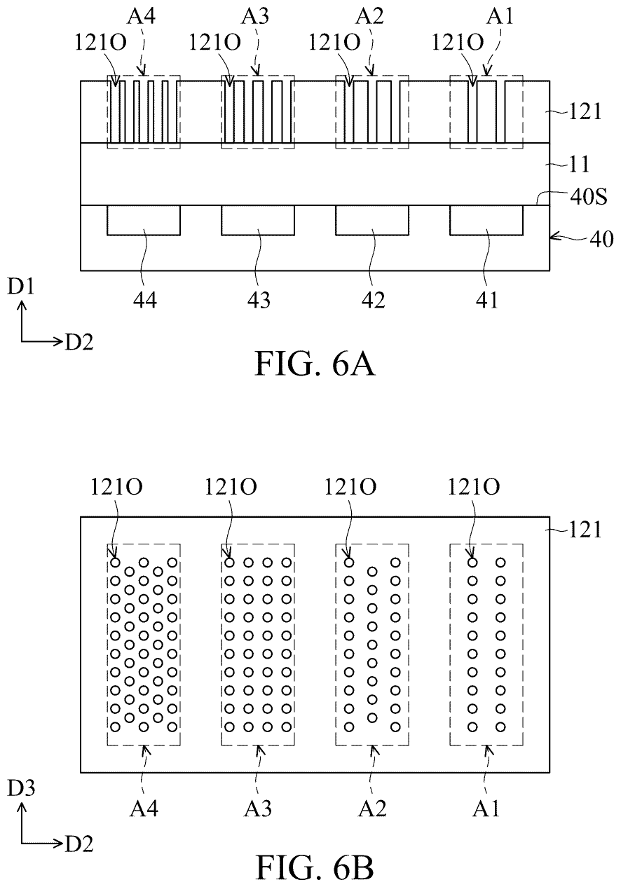

FIG. 6A is a schematic cross-sectional view of a bandpass filter obtained after step S403 of the embodiment, and FIG. 6B is a schematic top view of the bandpass filter of FIG. 6A. As shown in FIG. 6A, a space layer 12 including a plurality of openings 1210 through the base layer 121 is formed on the first reflector layer 11 after step S403, but the present disclosure is not limited thereto. In some embodiment, a space layer 12 including a plurality of recesses in the base layer 121 is formed on the first reflector layer 11 after step S403.

In some embodiments, step S403 may include a step of forming a pre-base layer on the first reflector layer 11 and a step of forming the openings 1210 in the pre-base layer, but the present disclosure is not limited thereto. In some embodiments, step S403 may include a step of forming a pre-base layer on the first reflector layer 11 and a step of forming the recesses in the pre-base layer.

In the step of forming the pre-base layer, the pre-base layer is formed by depositing a high refractive index material, a low refractive index material, or a combination thereof on the first reflector layer 11. Examples of the high refractive index material and the low refractive index material are as mentioned above, and will not be repeated here. The depositing process for the pre-base layer may include but not limited to a screen printing process, a physical vapor deposition (PVD) process, an ink jet printing process, a spin coating process, a chemical vapor deposition (CVD) process, other suitable methods, or any combination thereof.

The step of forming the openings 1210 may include a photolithography process. In some embodiments, the openings 1210 may be formed by coating a photoresist on the pre-base layer, performing a UV exposure process on the photoresist using a mask, removing the photoresist exposed to UV light, etching the pre-base layer using the remaining photoresist as a mask, and removing the remaining photoresist, but the present disclosure is not limited thereto. In some embodiment, the openings 1210 may be formed by a laser etching process.

The step of forming the openings 1210 may include using a mask having different hole distribution frequency patterns. Each of the hole distribution frequency patterns having a plurality of holes for forming the openings 1210. According to the desired opening shapes of the openings 1210, each of the holes may have a hole shape that is a circle, a square, a triangle, a pentagon, a hexagon, an octagon, a star, or another suitable shape. In some embodiments, the hole shape of the hole has a maximum width in a range of 120 nm to 1580 nm. In embodiments where the hole shape of the hole is a circle, the maximum width of the hole, i.e. the diameter of the circle, is within a range of 120 nm to 1580 nm. An interval between the centers of two adjacent holes may be smaller than the central wavelength of the desired wavelength band of the bandpass filter. In some embodiments, the interval is within a range of 200 nm to 1700 nm, but the present embodiment is not limited thereto.

In some embodiment, the openings 1210 may be formed at different densities in different portions of the pre-base layer using a mask having different hole distribution frequency patterns to form a base layer 121 including a plurality of portions separated from each other in the second direction D2. For example, as shown in FIGS. 6A and 6B, the base layer 121 formed in step S403 may include a first portion A1 corresponding the first sensor 41, a second portion A2 corresponding to the second sensor 42, a third portion A3 corresponding to the third sensor 43, and a fourth portion A4 corresponding to the fourth sensor 44. Some of the openings 1210 may be formed in the first portion A1 at a first density, some of the openings 1210 may be formed in the second portion A2 at a second density, some of the openings 1210 may be formed in the third portion A3 at a third density, and some of the openings 1210 may be formed in the fourth portion A4 at a fourth density using a mask having different hole distribution frequency patterns. In some embodiments, the first density, the second density, the third density, and the fourth density are different from each other as shown in FIGS. 6A and 6B. Intervals between the centers of two adjacent openings 1210 in the first portion A1 to the fourth portion A4 may be different from each other.

In some embodiment, step S403 may include a step of forming a pre-base layer on the first reflector layer 11 and a step of forming the recesses in the pre-base layer. The step of forming the recesses may be substantially the same as the step of forming the openings 1210. Therefore, the details of the step of forming the recesses will not be repeated here. For example, in some embodiments, some of the recesses may be formed in the first portion A1 at a first density, some of the recesses may be formed in the second portion A2 at a second density, some of the recesses may be formed in the third portion A3 at a third density, and some of the recesses may be formed in the fourth portion A4 at a fourth density using a mask having different hole distribution frequency patterns. In some embodiments, the first density, the second density, the third density, and the fourth density are different from each other.

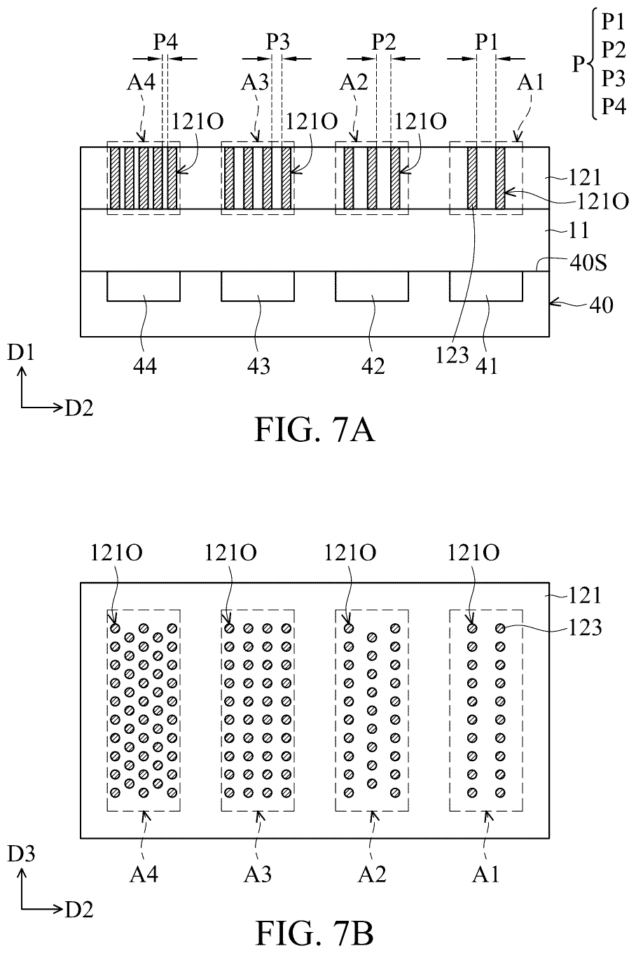

FIG. 7A is a schematic cross-sectional view of a bandpass filter obtained after step S405 of the embodiment, and FIG. 7B is a schematic top view of the bandpass filter of FIG. 7A. As shown in FIG. 7A, the microstructures 123 in step S405 are formed in each of the openings 1210 to form a space layer 12. Therefore, the cross-sectional shapes and shapes of the microstructures 123 may be substantially the same as the cross-sectional shapes and the opening shapes of the openings 1210. Some of the microstructures 123 may be formed in the first portion A1 at a first density, some of the microstructures 123 may be formed in the second portion A2 at a second density, some of the microstructures 123 may be formed in the third portion A3 at a third density, and some of the microstructures 123 may be formed in the fourth portion A4 at a fourth density. In some embodiments, the first density, the second density, the third density, and the fourth density are different from each other. A first pitch P1 between the centers of two adjacent microstructures 123 in the first portion A1, a second pitch P2 between the centers of two adjacent microstructures 123 in the second portion A2, a third pitch P1 between the centers of two adjacent microstructures 123 in the third portion A3, a fourth pitch P4 between the centers of two adjacent microstructures 123 in the fourth portion A4 may be different from each other.

Step S405 may include filling the first material into each of the openings 1210 to form the microstructures 123. The process for filling the first material into the openings 1210 may include, but is not limited to, a screen printing process, a physical vapor deposition (PVD) process, an ink jet printing process, a spin coating process, a chemical vapor deposition (CVD) process, another suitable method, or any combination thereof. In embodiments where the microstructure 123 includes a microstack structure, step S405 may further include filling a second material into each of the openings 1210 to form the microstructures 123. The process for filling the openings 1210 with the second material may be substantially the same as the process used with the first material.

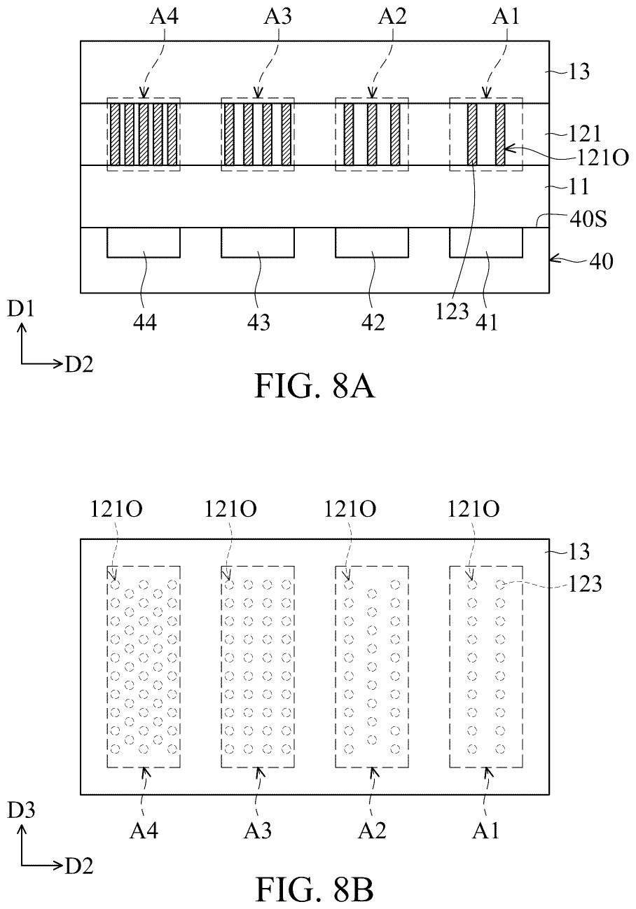

FIG. 8A is a schematic cross-sectional view of a bandpass filter obtained after step S407 of the embodiment, and FIG. 8B is a schematic top view of the bandpass filter of FIG. 8A. As shown in FIG. 8A, step S407 is performed on the space layer 12 to form the second reflector layer 13. The second reflector layer 13 formed in step S407 may be a high reflector layer having a reflection rate of 60-99.99% in a wavelength range of 400-700 nm, 700-1100 nm, or 1100-3400 nm. Step S407 may be substantially the same as step S401, and step S407 will not be repeated here. In some embodiments, step S401 and step S407 are the same one bandpass filter process.

The bandpass filter manufactured from the manufacturing method of the present disclosure can adjust a central wavelength of a wavelength band thereof by changing the effective refractive index of the space layer included in the bandpass filter. Further, in some embodiments, the bandpass filter can have regions having wavelength bands different from each other by making the effective refractive indices of different portions of the space layer different from each other.

One or more embodiments of the disclosure will be described in detail with reference to the following example. However, the example is only used to illustrate the embodiments of the disclosure and is not intended to limit the scope of the embodiments of the disclosure.

### [Preparation of Bandpass Filter 1]

Two layers of 51±5% nm Nb₂O₅ and one layer of 82±5% nm SiO₂ are deposited alternately in the first direction on a product including four sensors (a first sensor, a second sensor, a third sensor, and a fourth sensor) by physical vapor deposition processes to form a first reflector layer. The product has a top surface perpendicular to the first direction. Projections of the four sensors onto the top surface are not overlap each other. Each of the projections of the four sensors has an area of 60 μm×60 μm. The first reflector layer covers each of the fourth sensors.

A layer including SiO₂ is deposited on the first reflector layer by physical vapor deposition processes to form a 164.5±5% nm pre-base layer covering the fourth sensors. The pre-base layer includes four portions corresponding to the four sensors respectively. Accordingly, each of the four portions has an area substantially equal to each of the projections of the four sensors, respectively. In particular, the pre-base layer includes a first portion corresponds to the first sensor, a second portion corresponds to the second sensor, a third portion corresponds to the third sensor, and a fourth portion corresponds to the fourth sensor, and each of the first portion to the fourth portion has an area of 60 μm×60 μm.

Openings are formed in the pre-base layer by coating a photoresist on the pre-base layer, performing a UV exposure process on the photoresist using a mask, removing the photoresist exposed to UV light, etching the pre-base layer using the remaining photoresist as a mask, and removing the remaining photoresist. The mask used in the UV exposure process has a plurality of circular holes having a diameter of 120 nm arranged in different hole distribution frequency patterns corresponding to the first portion to the fourth portion. Therefore, each of the openings that is formed may have a an opening shape that is a circle with a diameter of 120 nm, as viewed from the first direction D1, and they may be arranged at different densities in the first portion to the fourth portion of the pre-base layer. In particular, there are 90000 openings formed in the first portion, 74529 openings formed in the second portion, 62500 openings formed in the third portion, and 53361 openings formed in the fourth portion. The sum of the areas of the openings in the first portion divided by the area of the first portion multiplied by 100% is 28.3% and an effective refractive index of the first portion is 1.738 for a light having a wavelength of 510 nm. The sum of the areas of the openings in the second portion divided by the area of the second portion multiplied by 100% is 23.4% and an effective refractive index of the second portion is 1.695 for a light having a wavelength of 510 nm. The sum of the areas of the openings in the third portion divided by the area of the third portion multiplied by 100% is 19.6% and an effective refractive index of the third portion is 1.661 for a light having a wavelength of 510 nm. The sum of the areas of the openings in the fourth portion divided by the area of the fourth portion multiplied by 100% is 16.8% and an effective refractive index of the fourth portion is 1.636 for a light having a wavelength of 510 nm. In the first portion, a minimum distance between two adjacent opens is 80 nm, an interval between the centers of the two adjacent openings is 200 nm, and a minimum distance between the opening adjacent to an edge of the first portion and the edge is 60 nm. In the second portion, a minimum distance between two adjacent opens is 100 nm, an interval between the centers of the two adjacent openings is 220 nm, and a minimum distance between the opening adjacent to an edge of the second portion and the edge is 20 nm. In the third portion, a minimum distance between two adjacent opens is 120 nm, an interval between the centers of the two adjacent openings is 240 nm, and a minimum distance between the opening adjacent to an edge of the third portion and the edge is 60 nm. In the fourth portion, a minimum distance between two adjacent opens is 120 nm, an interval between the centers of the two adjacent openings is 260 nm, and a minimum distance between the opening adjacent to an edge of the first portion and the edge is 40 nm. A space layer of the bandpass filter 1 may be completed after the above openings were formed in the pre-base layer.

Two layers of 51±5% nm Nb₂O₅ and one layer of 82±5% nm SiO₂ are deposited alternately in the first direction on the above space layer by physical vapor deposition processes to form a second reflector layer. The bandpass filter 1 of the present disclosure was completed after the second reflector layer was formed. The bandpass filter 1 of the present disclosure include a first region including the above first portion, a second region including the above second portion, a third region including the above third portion, and a fourth region including the above fourth portion.

### [Preparation of Bandpass Filter 2]

The bandpass filter 2 is manufactured substantially the same as the manufacturing method of the bandpass filter 1 except that the step of forming the openings and the step of forming a plurality of microstructures are not performed. Accordingly, the bandpass filter 2 has a structure substantially the same as that of the bandpass filter 1 except the space layer of the bandpass filter 2 does not include openings and microstructures, and an effective refractive index of the space layer of the bandpass filter 2 is 1.487 for a light having a wavelength of 510 nm.

### [Optical Properties of Example of Bandpass Filter]

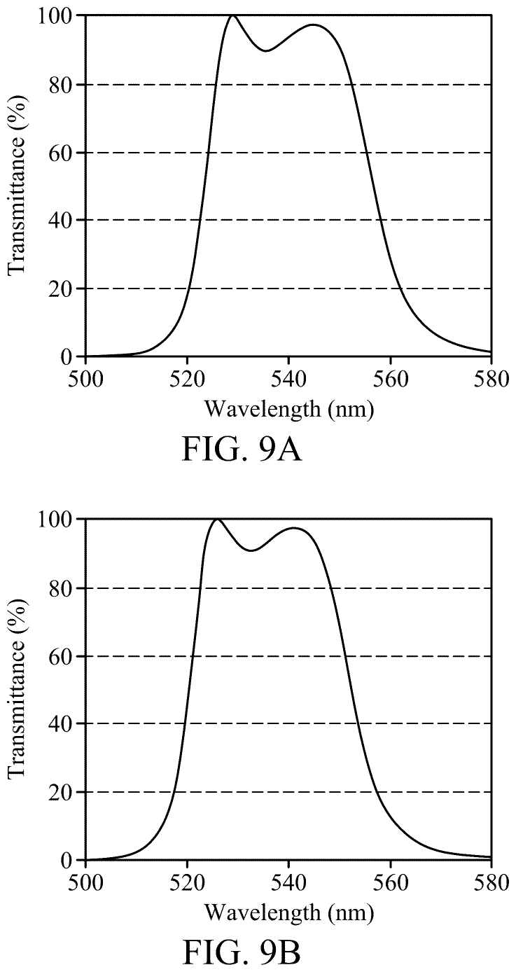

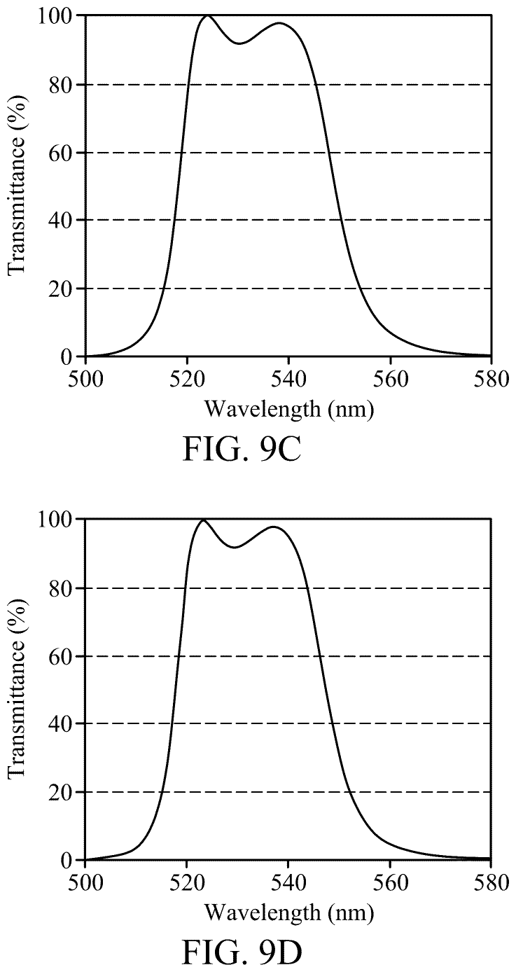

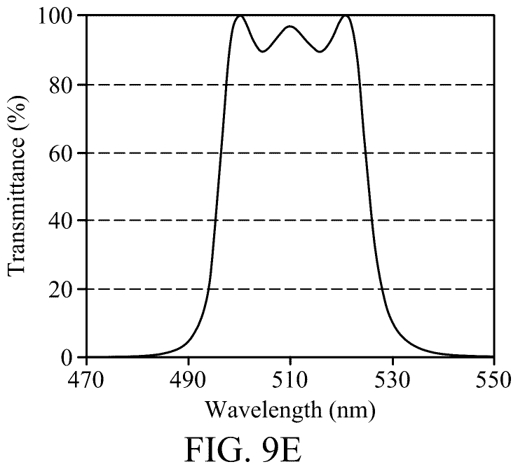

Transmittance spectrums of the first region, the second region, the third region, and the fourth region of the bandpass filter 1 and the bandpass filter 2 when an angle of incidence (AOI) is 0° were obtained by FDTD simulation. The description “an angle of incidence (AOI) is 0°” indicates that an angle between the first direction and an incident direction of a light is 0°. FIGS. 9A to 9D are transmittance spectrums of the first region to the fourth regions of the bandpass filter 1 according to an embodiment of the present disclosure, respectively. FIG. 9E is a transmittance spectrum of the bandpass filter 2 according to an embodiment of the present disclosure. A central wavelength of a wavelength band of the first region to the fourth regions of the bandpass filter 1 and the bandpass filter 2 can be obtained according to FIGS. 9A to 9E, and the result are listed in Table 1. A central wavelength of a wavelength band of the third region of the bandpass filter 1 when an angle of incidence is 20°, 40°, or 60° were obtained by FDTD simulation and the result are listed in Table 2.

TABLE 1

| | Bandpass filter 1 | | | | |
|---|---|---|---|---|---|
| | First | Second | Third | Fourth | Bandpass |
| | region | region | region | region | filter 2 |
| Effective refractive | 1.738 | 1.695 | 1.661 | 1.636 | 1.487 |
| index of the space | | | | | |
| layer | | | | | |
| Central wavelength | 537 nm | 534 nm | 531 nm | 530 nm | 510 nm |

TABLE 2

| Angle of incidence (AOI) | 0° | 20° | 40° | 60° |
|---|---|---|---|---|
| Effective refractive index of | 1.661 | | | |
| the space layer | | | | |
| Central wavelength | 531 nm | 529 nm | 500 nm | 476 nm |

According to Table 1 and FIGS. 9A to 9E, it is clearly that the bandpass filter manufactured from the manufacturing method of the present disclosure can adjust a central wavelength of a wavelength band thereof by forming microstructures in the space layer included in the bandpass filter. Further, the bandpass filter of the present disclosure can have regions having wavelength bands different from each other by forming microstructures at different densities in different portion of the space layer included in the bandpass filter. From Table 2, it can be observed that as the incident angle increases, the pass band shifts toward short wavelengths. This phenomenon is similar to the behavior of traditional optical multilayer films.

It is apparent that the bandpass filter manufactured from the manufacturing method of the present disclosure can adjust a central wavelength of a wavelength band thereof by forming microstructures in the space layer included in the bandpass filter. In some embodiments, the bandpass filter of the present disclosure can have regions having wavelength bands different from each other by forming microstructures at different densities in different portion of the space layer included in the bandpass filter.

Although embodiments of the present disclosure and the advantages thereof have been disclosed as described above, it should be understood that changes, substitutions and modifications may be made without departing from the spirit and scope of the disclosure. In addition, the protection scope of the present disclosure is not limited to the processes, machines, fabrications, compositions, devices, methods and steps in the specific embodiments described in the specification. According to the embodiments of the present disclosure, a person of ordinary skill in the art may understand that current or future processes, machines, fabrications, compositions, devices, methods and steps capable of performing substantially the same functions or achieving substantially the same results may be used in the embodiments of the present disclosure. Therefore, the protection scope of the present disclosure includes the above-mentioned processes, machines, fabrications, compositions, devices, methods and steps. In addition, features of different embodiments may be used together arbitrary as long as they do not violate the spirit of the disclosure or conflict with each other. Each claim constitutes an individual embodiment, and the protection scope of the present disclosure includes the combination of the claims and embodiments.

What is claimed is:

1. A bandpass filter, comprising:
a first reflector layer having a reflection rate of 60-99.99% in a wavelength range of 400-700 nm, 700-1100 nm, or 1100-3400 nm;
a second reflector layer disposed on the first reflector layer, wherein the second reflector layer has a reflection rate of 60-99.99% in a wavelength range of 400-700 nm, 700-1100 nm, or 1100-3400 nm; and
a space layer disposed between the first reflector layer and the second reflector layer in a first direction,
wherein the space layer comprises a plurality of microstructures comprising a first material having a refractive index and a base layer surrounding the plurality of microstructures and comprising a base material having a refractive index that is different from a refractive index of the first material.

2. The bandpass filter as claimed in claim 1, wherein the base layer comprises a plurality of openings through the base layer and/or a plurality of recesses in the base layer, and each of the plurality of microstructures is disposed in one of the openings or recesses.

3. The bandpass filter as claimed in claim 2, wherein when viewed from the first direction, one of the plurality of openings has a shape of a circle, a square, a triangle, a pentagon, a hexagon, an octagon, or a star.

4. The bandpass filter as claimed in claim 2, wherein in a cross-sectional view taken along the first direction, one of the plurality of openings has a cross-sectional shape of a rectangle, a square, a trapezoid, or an inverted trapezoid.

5. The bandpass filter as claimed in claim 2, wherein when viewed from the first direction, one of the plurality of recesses has a shape of a circle, a square, a triangle, a pentagon, a hexagon, an octagon, or a star.

6. The bandpass filter as claimed in claim 2, wherein in a cross-sectional view taken along the first direction, one of the plurality of recesses has a cross-sectional shape of a rectangle, a square, a trapezoid, an inverted trapezoid, an inverted triangle, a semi-circle, a U-shape, or a semi-ellipse.

7. The bandpass filter as claimed in claim 1, wherein the bandpass filter comprises a first region and a second region separated from the first region in a second direction perpendicular to the first direction, and a first wavelength band of the first region is different from a second wavelength band of the second region.

8. The bandpass filter as claimed in claim 7, wherein some of the microstructures are arranged in the first region at a first density and some of the other microstructures are arranged in the second region at a second density that is different from the first density.

9. The bandpass filter as claimed in claim 1, wherein both of the first reflector layer and the second reflector layer comprise high refractive index layers and low refractive index layers alternately stacked in the first direction.

10. The bandpass filter as claimed in claim 1, wherein a pitch between centers of two adjacent microstructures of the plurality of microstructures is smaller than a central wavelength of a wavelength band of the bandpass filter.

11. The bandpass filter as claimed in claim 1, wherein each of the plurality of microstructures comprises a microstack structure comprising layers stacked on each other, at least one of the layers comprises the first material, and another one of the layers comprises a second material having a refractive index that is different from the refractive index of the first material.

12. An optical structure, comprising:
a sensor layer; and
a bandpass filter disposed on the sensor layer, wherein the bandpass filter comprises:
a first reflector layer having a reflection rate of 60-99.99% in a wavelength range of 400-700 nm, 700-1100 nm, or 1100-3400 nm;
a second reflector layer disposed on the first reflector layer, wherein the second reflector layer has a reflection rate of 60-99.99% in a wavelength range of 400-700 nm, 700-1100 nm, or 1100-3400 nm; and
a space layer disposed between the first reflector layer and the second reflector layer in a first direction,
wherein the space layer comprises a plurality of microstructures comprising a first material, and a base layer surrounding the plurality of microstructures and comprising a base material having a refractive index that is different from the refractive index of the first material.

13. The optical structure as claimed in claim 12, wherein the bandpass filter comprises a first region and a second region separated from the first region in a second direction perpendicular to the first direction and a first wavelength band of the first region is different from a second wavelength band of the second region.

14. The optical structure as claimed in claim 13, wherein some of the microstructures are arranged in the first region at a first density and some of the other microstructures are arranged in the second region at a second density that is different from the first density.

15. The optical structure as claimed in claim 13, wherein the sensor layer comprises a first sensor corresponding to the first region and a second sensor corresponding to the second region.

16. A manufacturing method of a bandpass filter, comprising:
forming a first reflector layer having a reflection rate of 60-99.99% in a wavelength range of 400-700 nm, 700-1100 nm, or 1100-3400 nm;
forming a base layer comprising a plurality of openings through the base layer and/or a plurality of recesses in the base layer on the first reflector layer;
forming a plurality of microstructures in each of the plurality of openings and/or the plurality of recesses to form a space layer; and
forming a second reflector layer on the space layer, wherein the second reflector layer has a reflection rate of 60-99.99% in a wavelength range of 400-700 nm, 700-1100 nm, or 1100-3400 nm,
wherein the space layer comprises the plurality of microstructures and the base layer surrounding the plurality of microstructures, the plurality of microstructures comprises a first material having a refractive index, and the base layer comprises a base material having a refractive index that is different from the refractive index of the first material.

17. The manufacturing method of the bandpass filter as claimed in claim 16, wherein the step of forming the first reflector layer comprises alternately depositing high refractive index layers and low refractive index layers in the first direction on a top surface of a product having a first sensor and a second sensor, wherein the first sensor and the second sensor are separated from each other in directions perpendicular to the first direction.

18. The manufacturing method of the bandpass filter as claimed in claim 16, wherein the step of forming the base layer comprises:
forming a pre-base layer on the first reflector layer;
forming the openings and/or the recesses in a first portion of the pre-base layer at a first density; and
forming the openings and/or the recesses in a second portion of the pre-base layer at a second density, wherein the second portion is separated from the first portion in a second direction perpendicular to the first direction.

19. The manufacturing method of the bandpass filter as claimed in claim 18, wherein the step of forming the openings and/or the recesses comprises using a mask having different hole distribution frequency patterns.

20. The manufacturing method of the bandpass filter as claimed in claim 16, further comprising performing a planarization process after forming the plurality of microstructures in the openings and/or the recesses.
